(19) United States
(12) Patent Application Publication
(10) Pub. No.: US 2024/0166172 A1
(43) Pub. Date: May 23, 2024

(54) EMERGENCY BRAKING APPARATUS FOR VEHICLE

(71) Applicant: Hyun Soo KIM, Daejeon (KR)

(72) Inventor: Hyun Soo KIM, Daejeon (KR)

(21) Appl. No.: 18/249,998

(22) PCT Filed: Aug. 17, 2021
(86) PCT No.: PCT/KR2021/010887

§ 371 Date: Apr. 21, 2023

(30) Foreign Application Priority Data
Jul. 20, 2021 (KR) 10-2021-0094929

(51) Int. Cl. B60T 1/14; B60T 13/74

(52) U.S. Cl. CPC B60T 1/14; B60T 13/746; B60T 2201/03

(57) ABSTRACT

A vehicle emergency braking apparatus performing emergency braking without slipping in high- and low-velocity states to inhibit accidents or reduce damage. A braking body has one end axially coupled to a lower side of the vehicle and the other end provided with a braking blade to generate braking force when in contact with the ground. An electric winch is provided on the lower portion of the vehicle to be spaced apart from the braking body, and winds or unwinds a main wire connected to the other end of the braking body. A returning member having elastic force toward the vehicle is connected to the other end of the braking body. When the main wire is wound by the electric winch, the other end of the braking body is pushed by force greater than elastic force of the returning member so that the braking blade comes into contact with the ground.

### CROSS-REFERENCE TO RELATED APPLICATIONS

This application is the U.S. national stage application of International Patent Application No. PCT/KR2021/010887, filed Aug. 17, 2021, which claims the benefit under 35 U.S.C. § 119 of Korean Application No. 10-2021-0094929, filed Jul. 20, 2021, the disclosures of each of which are incorporated herein by reference in their entirety.

### TECHNICAL FIELD

The present disclosure relates to a vehicle emergency braking apparatus and, more particularly, to a vehicle emergency braking apparatus able to brake the vehicle to inhibit slipping of the vehicle, thereby inhibiting an accident or reducing damage caused by an accident.

### BACKGROUND ART

A vehicle such as an automobile is provided with an anti-lock brake system (ABS) to inhibit wheel locking during emergency braking. Such an ABS has excellent performance for inhibiting a vehicle from slipping sideways. However, there are problems in that a significant amount of time is taken to immediately control and stop a vehicle slipping on a snowy or icy road and it is difficult to cope with unexpected situations.

In addition, vehicles may be provided with snow tires in order to inhibit slipping on a snowy or icy road. However, snow tires may not be effective when vehicles are in a high-speed state.

Considering situations that are difficult to cope with using the ABS brake and/or snow tires, hot wires are constructed in a section of road that is frequently covered in snow or ice in order to inhibit snow or ice from accumulating on the road. However, the construction of hot wires in the road is expensive. Salt water sprays may also be used. However, salt water sprays are not only expensive but also have a risk of freezing.

### DISCLOSURE

### Technical Problem

Accordingly, the present disclosure has been made keeping in mind the above problems occurring in the prior art, and an objective of the present disclosure is to provide a vehicle emergency braking apparatus able to perform emergency braking of a vehicle without slipping not only in a low-speed state but also in a high-speed state, thereby inhibiting an accident or reducing damage caused by an accident.

### Technical Solution

In order to accomplish the above objective, the present disclosure provides a vehicle emergency braking apparatus including: a braking body, with one end thereof being axially coupled to a lower portion of a vehicle, the braking body including a braking blade provided on the other end thereof to generate braking force when in contact with the ground; and an electric winch provided on the lower portion of the vehicle to be spaced apart from the braking body to wind or unwind a main wire connected to the other end of the braking body, wherein a return member configured to apply elastic force in the direction toward the vehicle is connected to the other end of the braking body, such that the other end of the braking body is pulled by force greater than elastic force of the return member to come into contact with the ground as the main wire is pulled using the electric winch.

The vehicle emergency braking apparatus may further include an operation control module including a main lever by which forward power or reverse power is applied to the electric winch and a first blocking member configured to apply elastic force to the main lever so that the main wire remains in an unwound state at ordinary times in response to application of reverse power to the electric winch, wherein when the main lever is pulled by force greater than elastic force of the first blocking member, forward power is applied to the electric winch 200 so that the main wire is wound.

The braking body may be axially rotated so that the braking blade comes into contact with the ground as the main wire is pulled in response to forward rotation of the rotating shaft of the electric winch. The vehicle emergency braking apparatus may further include an anti-backward rotation module configured to block reverse power applied to the electric winch in response to the main lever being operated, thereby inhibiting further backward rotation of the rotating shaft, when the main wire is completely unwound in response to backward rotation of the rotating shaft.

The anti-backward rotation module may include a secondary lever configured to block reverse power or release blocking of reverse power, a secondary wire having one end fixed to the rotating shaft and the other end fixed to the secondary lever, the secondary wire being wound on the rotating shaft in a direction opposite a direction in which the main wire is wound, and a second blocking member configured to apply elastic force so that the secondary lever releases blocking of reverse power. As the secondary wire is wound on and comes into close contact with the rotating shaft in response to backward rotation of the rotating shaft, the secondary lever may be pulled by force greater than elastic force of the second blocking member so that reverse power is blocked. As the secondary wire is loosened in response to forward rotation of the rotating shaft, the secondary wire may be pulled using the second blocking member so that blocking of reverse power is released.

The vehicle emergency braking apparatus may further include a mounting body mounted on the lower portion of the vehicle and having a front end portion to which one end of the braking body is axially coupled. The return member may include two return members, with one end of each of the two return members being fixed adjacent to a corresponding one of one end and the other end of the braking blade, and the other end of each of the two return members being fixed to a central portion of a rear end portion of the mounting body.

### Advantageous Effects

According to the present disclosure, when the main wire is wound using the electric winch, the other end of the braking body is pulled by force greater than elastic force of the return member. Consequently, it is possible to perform emergency braking of a vehicle without slipping not only in a low-speed state but also in a high-speed state, thereby inhibiting an accident or reducing damage caused by an accident. In particular, it is possible to effectively perform emergency braking of the vehicle on a snowy or icy road, and the vehicle emergency braking apparatus may be usefully used even in the case of sudden departure.

### DESCRIPTION OF DRAWINGS

FIG. 1 is a bottom perspective view illustrating a state in which a vehicle emergency braking apparatus according to the present disclosure is disposed on a vehicle;

FIG. 2 is a bottom perspective view illustrating structures of the braking body and the mounting body used in the vehicle emergency braking apparatus according to the present disclosure;

FIG. 3 is a bottom view illustrating the structures of the braking body and the mounting body used in the vehicle emergency braking apparatus according to the present disclosure;

FIG. 4 is a bottom perspective view illustrating a rotated state of the braking body used in the vehicle emergency braking apparatus according to the present disclosure;

FIG. 5 is a perspective view illustrating the operation control module used in the vehicle emergency braking apparatus according to the present disclosure;

FIG. 6 is a schematic view illustrating state of respective components when the main wire used in the vehicle emergency braking apparatus according to the present disclosure is unwound;

FIG. 7 is a schematic view illustrating states of respective components when the main wire used in the vehicle emergency braking apparatus according to the present disclosure is wound in the forward direction;

FIG. 8 is a side view illustrating a state in which the vehicle emergency braking apparatus according to the present disclosure is disposed on an automobile;

FIG. 9 is a side view illustrating a state in which the vehicle emergency braking apparatus according to the present disclosure is disposed on an automobile and the braking body is rotated for emergency braking; and

FIG. 10 is a side view illustrating a state in which the vehicle emergency braking apparatus according to the present disclosure is disposed on a truck and the braking body is rotated for emergency braking.

### BEST MODE

The present disclosure proposes a vehicle emergency braking apparatus able to perform emergency braking of a vehicle without slipping not only in a low-speed state but also in a high-speed state, thereby inhibiting an accident or reducing damage caused by an accident. The vehicle emergency braking apparatus includes: a braking body, with one end thereof being axially coupled to a lower portion of a vehicle, the braking body comprising a braking blade provided on the other end thereof to generate braking force when in contact with the ground; and an electric winch provided on the lower portion of the vehicle to be spaced apart from the braking body to wind or unwind a main wire connected to the other end of the braking body, wherein a return member configured to apply elastic force in the direction toward the vehicle is connected to the other end of the braking body, such that the other end of the braking body is pulled by force greater than elastic force of the return member to come into contact with the ground as the main wire is pulled using the electric winch.

The scope of the present disclosure is not limited to embodiments to be described below, but may be implemented in a variety of forms by those skilled in the art without departing from the technical principle of the present disclosure.

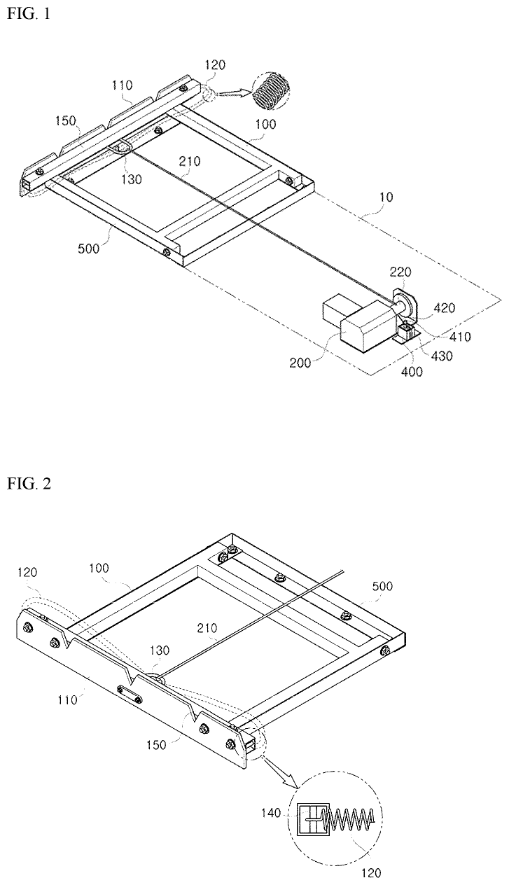

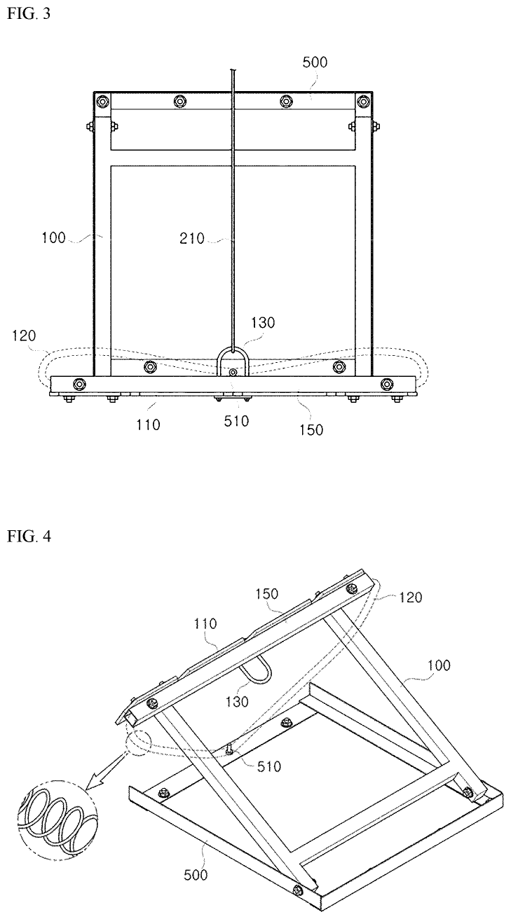

Hereinafter, a vehicle emergency braking apparatus according to the present disclosure will be described in detail with reference to FIGS. 1 to 10.

As illustrated in FIGS. 1 to 4, the vehicle emergency braking apparatus according to the present disclosure includes a braking body 100 provided in the lower portion of a vehicle 10 and an electric winch 200 for rotating the braking body 100 about the axis thereof.

One end of the braking body 100 is axially coupled to the lower portion of the vehicle 10, and a braking blade 110 for generating braking force when in contact with the ground is provided on the other end of the braking body 100. The braking body 100 may have, for example, the shape of a bar having a predetermined length. However, as illustrated in FIGS. 1 to 4, the braking body 100 may have the shape of an oblong frame to have sufficient strength by considering that the braking blade 110 is in contact with the ground.

In addition, the braking blade 110 may have a variety of shapes. However, the braking blade 110 may have the shape of an upright plate, the length of which is a longer than that of one end of the braking body 100, may have a plurality of protrusions along peripheral portions in contact with the ground, or may have a friction member on a peripheral portion in contact with the ground, as illustrated in FIGS. 1 to 4.

In addition, a fixed frame 150, the length of which is the same as or similar to that of the braking blade 110, may be provided on another end of the braking body 100 such that the braking blade 110 longer than one end of the braking body 100 is stably provided. A coupling hook 130 may be provided on the central portion of the fixed frame 150 such that one end of a main wire 210 of the electric winch 200 to be described later is connected to the coupling hook 130.

The braking body 100 may be directly mounted on the lower portion of the vehicle 10 such that one end of the braking body 100 is axially coupled to the lower portion of the vehicle 10. However, as illustrated in FIG. 1, the braking body 100 may be disposed on the lower side of the vehicle 10 through a mounting body 500.

The mounting body 500 may be provided in a variety of shapes to conform to the shape of the braking body 100. For example, as illustrated in the drawings, the mounting body 500 may have the shape of an oblong frame covering both sides of the braking body 100. In addition, one end of the braking body 100 is axially coupled to the front end portion of the mounting body 500. Specifically, both sides of the front end portion of the mounting body 500 may be axially coupled to one end of the braking body 100, such that the braking body 100 including the other end may rotate about one end of the braking body 100.

As described above, in the present disclosure, when the braking body 100 including the other end rotates about one end of the braking body 100, the braking blade 110 comes into contact with the ground, thereby performing emergency braking. The braking body 100 is provided with return members 120 to ensure emergency braking is performed to the extent required by a user and to inhibit the braking body 100 from rotating in an unnecessary situation.

The return members 120 are connected to the other end of the braking body 100 such that elastic force acts toward the vehicle 10. As a specific example, each of the return members 120 may be implemented as an elastic spring. As illustrated in FIG. 2, fixing rods 140 may be provided on both ends of the fixed frame 150, and one end of each of the return members 120 may be fixed to the corresponding fixing rod 140. A fixing bolt 510 may be provided in the central portion of the rear end portion of the mounting body 500 to fix the other ends of the return members 120.

That is, two return members 120 may be provided such that one end of each of the return members 120 is fixed to corresponding one of the fixing rods 140 adjacent to one end and the other end of the braking blade 110 and the other end of each of the return members 120 is fixed through the fixing bolt 510 on the central portion of the rear end portion of the mounting body 500. The return members 120 connected in this manner apply elastic force to the braking body 100 in the direction toward the vehicle 10 when the braking body 100 is rotated. At this time, since the return members 120 and the braking blade 110 (or the fixed frame 150) are arranged in the shape of a triangle, the rotated braking body 100 may return to the original position without excessive vibration.

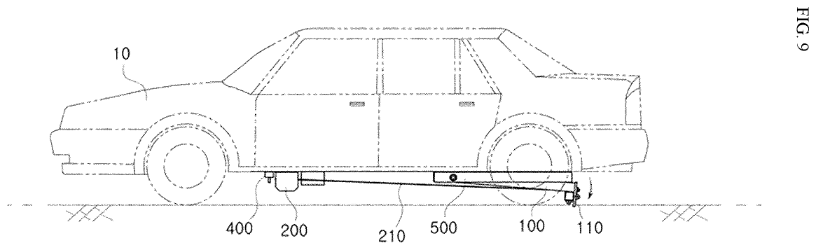

In order to axially rotate the braking body 100, the electric winch 200 is used in the present disclosure. As illustrated in FIG. 1, the electric winch 200 is provided on the lower portion of the vehicle 10 to be spaced apart from the braking body 100, and is configured to wind or unwind the main wire 210 connected to the other end of the braking body 100. For example, when the braking body 100 is disposed adjacent to a rear wheel of the vehicle 10 as illustrated in FIGS. 8 to 10, the electric winch 200 may be disposed on a lower location of the vehicle 10 positioned forward of the braking body 100.

One end of the main wire 210 is connected to the coupling hook 130 provided on the central portion of the other end of the braking body 100, and the other end of the main wire 210 is connected to a rotating shaft 220 of the electric winch 200. Here, the rotating shaft 220 may be provided to be located on the same line as a point at which the coupling hook 130 is provided. The main wire 210 may be configured such that the length thereof corresponds to the distance between the rotating shaft 220 and the coupling hook 130 so that emergency braking may be performed in an emergency.

Thus, in the present disclosure, at the occurrence of a situation in which emergency braking is required, as the main wire 210 is wound using the electric winch 200, the other end of the braking body 100 is pulled by force greater than elastic force of the return members 120 and thus the braking blade 110 comes into contact with the ground, as illustrated in FIGS. 4, 9, and 10. Not only in a low-speed state of the vehicle 10 but also in a high-speed state of the vehicle 10, emergency braking may be performed without slipping, thereby inhibiting an accident or reducing damage caused by an accident. In particular, emergency braking of the vehicle may be effectively performed on a snowy or icy road and be usefully performed even in the case of sudden departure.

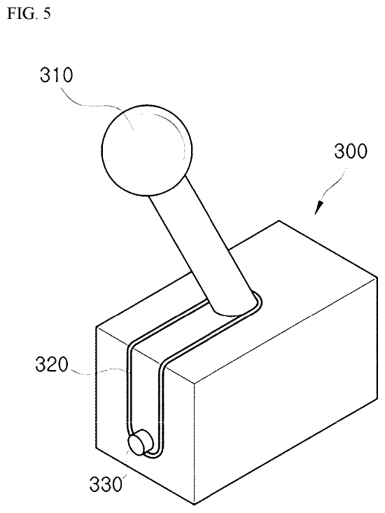

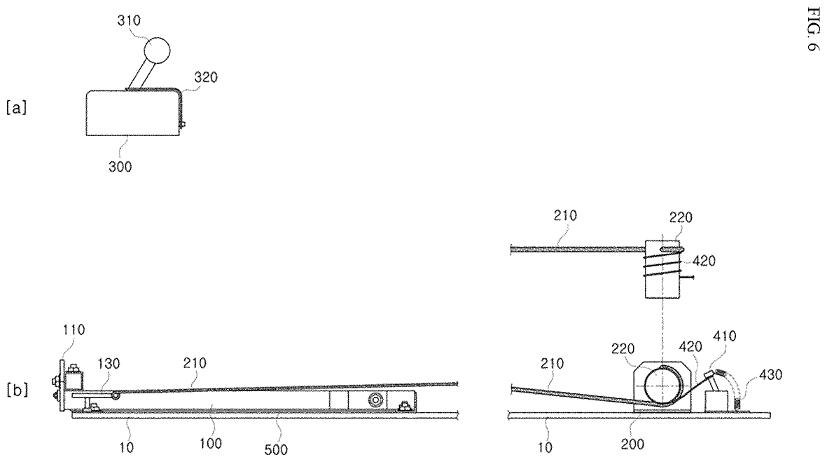

In addition, the present disclosure may further include an operation control module 300 that the user controls to axially rotate the braking body 100. For example, the operation control module 300 may include a main lever 310 as illustrated in FIG. 5. The main lever 310 is configured to apply forward power or reverse power to the electric winch 200 when operated by the user. When forward power is applied to the electric winch 200 as the main lever 310 is operated, the main wire 210 is wound on the rotating shaft 220. When reverse power is applied to the electric winch 200 in a state in which the main wire 210 is wound on the rotating shaft 220, the main wire 210 is unwound.

In addition, the operation control module 300 may further include a configuration allowing the braking body 100 to constantly remain in a state in which the braking body 100 is not axially rotated unless the user operates the operation control module 300 to apply forward power to the electric winch 200. For example, as illustrated in FIG. 5, the operation control module 300 may further include a first blocking member 320 configured to apply elastic force to the main lever 310 to apply reverse power to the electric winch 200 so that the main wire 210 remains in the unwound state at ordinary times.

Specifically, the first blocking member 320 may be implemented as an elastic band that forms a closed curve, and may be configured such that the main lever 310 is pulled by elasticity in the direction in which reverse power is applied. In this regard, the main lever 310 may be located on the inner portion of one end of the first blocking member 320, and a fixing member 330 protruding from a control module body may be located on the inner portion of the other end of the first blocking member 320.

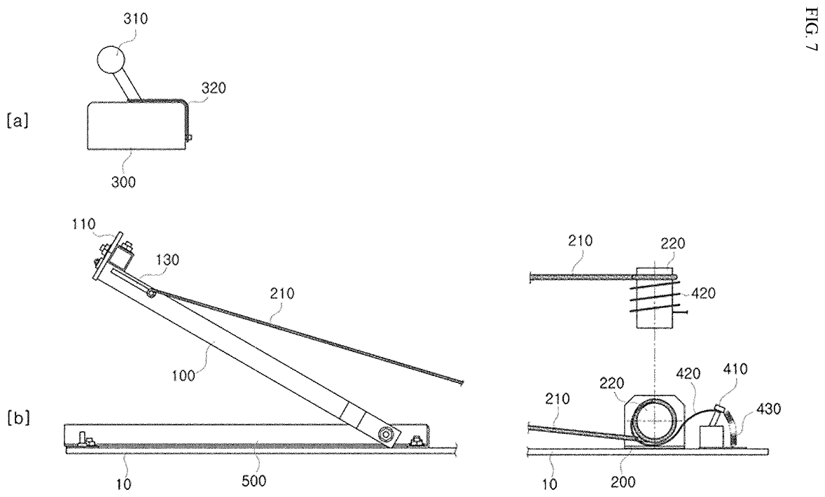

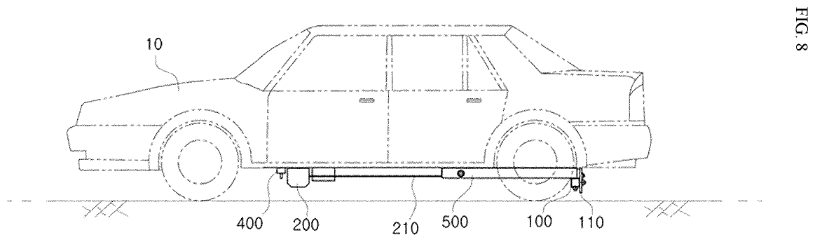

Due to this operation control module 300, the braking body 100 remains in a state in which the braking body 100 is not axially rotated, as illustrated in FIG. 6. As illustrated in FIG. 7, when emergency braking is required, the user pulls the main lever 310 in the opposite direction with force greater than elastic force of the first blocking member 320 to apply forward power to the electric winch 200. Then, the main wire 210 is pulled to rotate the braking body 100 about the axis thereof, and thus the braking blade 110 comes into contact with the ground.

In addition, the operation control module 300 applies reverse power to the electric winch 200 state at ordinary times. When the rotating shaft 220 is rotated by continuous application of reverse power even in the case that the main wire 210 is completely unwound from the rotating shaft 220, the main wire 210 is wound, due to forward power, in the direction opposite to the direction in which the main wire 210 is wound on the rotating shaft 220. Since this causes undesired rotation of the braking body 100, the present disclosure may further include an anti-backward rotation module 400 to inhibit such undesired rotation.

When the rotating shaft 220 is rotated backward and the main wire 210 is completely unwound, the anti-backward rotation module 400 blocks reverse power applied to the electric winch 200 in response to the main lever 310 being operated, thereby inhibiting further backward rotation of the rotating shaft 220. The anti-backward rotation module 400 may be configured to operate in a variety of methods. For example, as illustrated in FIG. 1, the anti-backward rotation module 400 may include a secondary lever 410, a secondary wire 420, and a second blocking member 430. The anti-backward rotation module 400 may be provided adjacent to the electric winch 200.

The secondary lever 410 blocks reverse power or releases the blocking of reverse power in response to movement in one direction or the other direction. One end of the secondary wire 420 is fixed to the rotating shaft 220 of the electric winch 200, and the other end of the secondary wire 420 is fixed to the secondary lever 410. In response to application of forward power, the secondary wire 420 is wound on the rotating shaft 220 in the direction opposite to the direction in which the main wire 210 is wound.

That is, when the main wire 210 is unwound as the rotating shaft 220 is rotated backward in response to reverse power being applied to the electric winch 200, the secondary wire 420 is wound on and comes into close contact with the rotating shaft 220 at the same time. In contrast, when the main wire 210 is wound as the rotating shaft 220 is rotated forward in response to power being applied to the electric winch 200, the secondary wire 420 is loosened from the rotating shaft 220 at the same time. In this case, the secondary wire 420 is loosened instead of being unwound from the rotating shaft 220 since the anti-backward rotation module 400 is provided adjacent to the electric winch 200. In addition, the secondary wire 420 is loosened instead of being unwound from the rotating shaft 220 in order to inhibit the secondary wire 420 from being tangled with the main wire 210.

The second blocking member 430 may apply elastic force so that the secondary lever 410 is positioned to release the blocking of reverse power. For example, the second blocking member 430 may be implemented as an elastic spring. One end of the elastic spring may be fixed to the secondary lever 410, and the other end of the elastic spring may be fixed to the bottom surface of the anti-backward rotation module 400 positioned opposite the side on which the electric winch 200 is provided.

Thus, as illustrated in FIG. 6, when the main wire 210 is completely unwound in response to backward rotation of the rotating shaft 220, the secondary wire 420 is wound on and comes into close contact with the rotating shaft 220. Consequently, the secondary lever 410 is pulled toward the electric winch 200 by force greater than elastic force of the second blocking member 430 to block reverse power applied to the electric winch 200 in response to the main lever 310 being operated. As a result, the main wire 210 is not wound backward and remains in the completely unwound state at ordinary times.

In contrast, as illustrated in FIG. 7, when the rotating shaft 220 is rotated forward and the main wire 210 is wound on the rotating shaft 220 at the occurrence of a situation in which emergency braking is required, the secondary wire 420 is loosened from the rotating shaft 220. Consequently, due to elastic force of the second blocking member 430, the secondary lever 410 is pulled in the direction opposite to the direction in which the electric winch 200 is provided, thereby releasing the blocking of reverse power.

That is, when the user performs emergency braking by axially rotating the braking body 100 by operating the main lever 310 and then releases the operation of the main lever 310, the main lever 310 is moved to a state in which reverse power is applied by the first blocking member 320. Consequently, due to supplied reverse power, the electric winch 200 rotates the rotating shaft 220 backward until the main wire 210 is completely unwound.

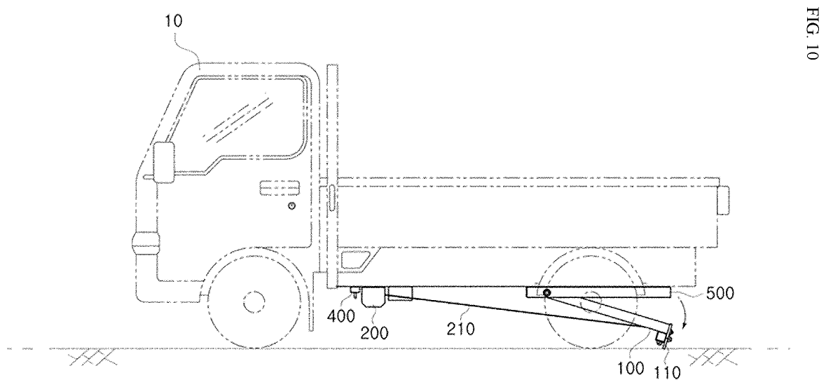

The vehicle emergency braking apparatus according to the present disclosure as set forth above is disposed on the lower portion of the vehicle 10, as illustrated in FIGS. 8 to 10. In a situation in which emergency braking is required, as illustrated in FIGS. 9 and 10, the braking blade 110 may come into contact with the ground, thereby performing emergency braking of the vehicle 10 without slipping.

<Description of the Reference Numerals in the Drawings>

| | |
|---|---|
| 10: vehicle | |
| 100: braking body | 110: braking blade |
| 120: return member | 130: coupling hook |
| 140: fixing rod | 150: fixed frame |
| 200: electric winch | 210: main wire |
| 220: rotating shaft | |
| 300: operation control module | |
| 310: main lever | |
| 320: first blocking member | |
| 330: fixing member | |
| 400: anti-backward rotation module | |
| 410: secondary lever | |
| 420: secondary wire | 430: second blocking member |
| 500: mounting body | 510: fixing bolt |

What is claimed is:

1. A vehicle emergency braking apparatus comprising:
a braking body (100) having two ends, with one end thereof being axially coupled to a lower portion of a vehicle (10), the braking body (100) comprising a braking blade (110) provided on the other end thereof to generate braking force when in contact with a ground surface; and
an electric winch (200) provided on the lower portion of the vehicle (10) to be spaced apart from the braking body (100) to wind or unwind a main wire (210) connected to the other end of the braking body (100),
wherein a return member (120) configured to apply elastic force in a direction toward the vehicle (10) is connected to the other end of the braking body (100), such that the other end of the braking body (100) is pulled by force greater than elastic force of the return member (120) to come into contact with the ground as the main wire (210) is pulled using the electric winch (200).

2. The vehicle emergency braking apparatus according to claim 1, further comprising an operation control module (300) comprising a main lever (310) by which forward power or reverse power is applied to the electric winch (200) and a first blocking member (320) configured to apply elastic force to the main lever (310) so that the main wire (210) remains in an unwound state at ordinary times in response to application of reverse power to the electric winch (200),
wherein when the main lever (310) is pulled by force greater than elastic force of the first blocking member (320), forward power is applied to the electric winch 200 so that the main wire (210) is wound.

3. The vehicle emergency braking apparatus according to claim 2, wherein the braking body (100) is axially rotated so that the braking blade (110) comes into contact with the ground as the main wire (210) is pulled in response to forward rotation of the rotating shaft (220) of the electric winch (200),
the vehicle emergency braking apparatus further comprising an anti-backward rotation module (400) configured to block reverse power applied to the electric winch (200) in response to the main lever (310) being operated, thereby inhibiting further backward rotation of the rotating shaft (220), when the main wire (210) is completely unwound in response to backward rotation of the rotating shaft (220).

4. The vehicle emergency braking apparatus according to claim 3, wherein the anti-backward rotation module (400) comprises a secondary lever (410) configured to block reverse power or release blocking of reverse power, a secondary wire (420) having two ends with one end fixed to the rotating shaft (220) and the other end fixed to the secondary lever (410), the secondary wire (420) being wound on the rotating shaft (220) in a direction opposite a direction in which the main wire (210) is wound, and a second blocking member (430) configured to apply elastic force so that the secondary lever (410) releases blocking of reverse power,
wherein as the secondary wire (420) is wound on and comes into close contact with the rotating shaft (220) in response to backward rotation of the rotating shaft (220), the secondary lever (410) is pulled by force greater than elastic force of the second blocking member (430) so that reverse power is blocked, and
as the secondary wire (420) is loosened in response to forward rotation of the rotating shaft (220), the secondary wire (420) is pulled using the second blocking member (430) so that blocking of reverse power is released.

5. The vehicle emergency braking apparatus according to claim 1, further comprising a mounting body (500) mounted on the lower portion of the vehicle (10) and having a front end portion to which one end of the braking body (100) is axially coupled,
wherein the return member (120) comprises two return members (120) each having two ends, with one end of each of the two return members (120) being fixed adjacent to a corresponding one of one end and the other end of the braking blade (110), and the other end of each of the two return members (120) being fixed to a central portion of a rear end portion of the mounting body (500).
